(19) United States
(12) Patent Application Publication
(10) Pub. No.: US 2001/0025245 A1
(43) Pub. Date: Sep. 27, 2001

(54) E-registrar

(76) Inventors: Gregory C. Flickinger, Furlong, PA (US); Frederik M. Dewolf, Ithaca, NY (US); Steven Lutter, Trumansburg, NY (US); Charles A. Eldering, Doylestown, PA (US)

Correspondence Address: Douglas J. Ryder, Technology, Patents and Licensing, Inc., 340 North Broad Street, Doylestown, PA, 18901, US

(21) Appl. No.: 09/740,051

(22) Filed: Dec. 18, 2000

Related U.S. Application Data
(60) Provisional application No. 60/172,397, filed on Dec. 17, 1999.

(51) Int. Cl. G06F 17/60

(52) U.S. Cl. 705/1

(57) ABSTRACT

A method for automatic asset registration. An electronic registration database is provided by an asset manufacturer or third party, such as a credit card company. An electronic data file comprising data specific to an entity that purchases or owns assets is provided. The data file can be loaded onto a purchasing or owner entity's computer or installed on a smart credit card. In one embodiment, the data file is loaded onto a third party's computer. The data specific to an entity is extracted from the electronic file and entered into the registration database. Data specific to an asset is also entered into the registration database and associated with the data specific to an entity; thereby registering the asset for the entity.

This application claims priority under 35 U.S.C. §119(e) for provisional application No. 60/172,397, filed on Dec. 17, 1999.

The present application is also related to Applicants co-pending U.S. patent application (docket T900-10) filed on Dec. 18, 2000 and entitled “Global Asset Information Registry”.

All of the aforementioned applications are incorporated herein by reference, but are not admitted to be prior art.

### BACKGROUND OF THE INVENTION

When an individual, group, or business purchases or leases a product or service, that product or service may be registered. Registration typically encompasses providing information concerning the product or service and concerning the purchaser to the manufacturer/service provider, re-seller, or some other party or enterprise involved in the production, sale, warranty, service, or other responsibility regarding the product or service. Products and services can generally be termed assets as they have some tangible value. Examples of assets that are registered and the parties that require registration include: software registered with the manufacturer, electronics registered with the manufacturer or reseller, durable goods registered with the manufacturer or reseller, and automobiles registered with a governmental organization.

Typically when an asset is purchased, a registration and/or warranty card will be enclosed in the packaging with the asset. The purchaser of the asset is requested to fill-out the registration and/or warranty card and mail it to the interested party (e.g., the manufacturer). In the case of some assets which are purchased at a retail outlet or on-line, the purchaser is asked to register the asset on-line via an Internet connection. In either case, the user must perform the product or warranty registration manually (i.e., fill out the card by hand and mail it or log onto the Internet and enter the requested information). In the case where the asset is computer programming, or software, (whether purchased on the Internet or in a shrink wrapped, or boxed set through a retailer, the installation process typically includes an ‘automatic’ registration process that guides the purchaser through the process of submitting the information electronically). In some instances this involves creating a data set by the employment of dialogue boxes, or wizards, that prompt the user for input and makes a record of the responses. The user is then prompted to connect to the Internet and the data is transferred. In another variation, a browser window is launched and the browser is redirected to a particular URL, or web server address and a data input form presented to the purchaser for completion and submission. In either variation, these methods still require the user to repeat the input process each time a new program or software package is registered. This process can be time-consuming and tedious, particularly when multiple assets and multiple enterprises are involved. For this and other reasons product and/or warranty registrations are not always completed. As a result, valuable marketing and product usage information is not available to manufacturers and other enterprises, and purchasers do not always avail themselves of available warranty and recall protection. In the case of mandatory registrations, significant labor is expended policing registration processes.

A need still exists for a method of registering assets that requires a minimum of effort by the purchaser, thereby increasing the likelihood of asset registration. It is an object of the present invention to provide an efficient method for asset registration. It is a further object of the present invention to provide a method for automatic registration of assets as a part of a purchasing transaction. It is yet a further object to use a method of asset registration as an incentive to engage in business with a particular enterprise. A further object is to automatically insure an asset

### SUMMARY OF THE INVENTION

To achieve these and other objectives, and in view of its purposes, the present invention provides an efficient method for electronically registering assets.

In one embodiment of the present invention, a method is provided for automatically registering an asset as part of a purchasing transaction for that asset.

An electronic file, called E-registrar is created which is accessible during an on-line or credit card purchasing transaction. The electronic file contains data specific to the purchasing entity, including such information as would typically be requested for registration of an asset (e.g., name, address, and marketing information). The data in the E-registrar is extracted by the purchasing transaction application, the credit approval application, or another application activated by one of the parties to the transaction. The purchaser-specific data is then sent to a registration database. Asset information, such as classification and identification of a specific asset, is input, sent to the registration database, and associated with the purchaser-specific data.

The present invention provides significant advantages over the prior art. In the present invention entity-specific data would only need to be manually entered once during creation of the E-registrar, instead of repetitively for each asset to be registered. Also, changes to entity-specific information, such as address, could be available for each asset registered in the registration database, including those assets registered prior to the change. The convenience of the present invention could increase registration, providing better marketing information to manufacturers and other interested parties.

It should be understood that both the foregoing general description and the following detailed description are exemplary, but are not restrictive, of the invention.

### BRIEF DESCRIPTION OF THE DRAWINGS

The features and advantages of a method for electronically registering assets will be more clearly understood from the following description when read in connection with the accompanying drawing. Included in the drawing are the following figures:

In the drawings:

FIG. 1 is a block diagram of an asset registration process wherein the asset is purchased on-line from the manufacturer or re-seller and the manufacturer or re-seller provides the asset registration database;

FIG. 2 is a block diagram of an asset registration process wherein the asset is purchased on-line from the manufacturer or re-seller and a third party provides the asset registration database;

FIG. 3A is a block diagram of an asset registration process wherein an asset created by a manufacturer is purchased at a conventional retailer, and a third party provides the asset registration database;

FIG. 3B illustrates the asset registration process, wherein the third party maintains the E-registrar; and

FIG. 4 is a block diagram of an asset registration process wherein an asset is purchased from an on-line re-seller, the manufacturer provides the asset registration database, and the purchaser communicates the E-registrar data directly to the manufacturer.

### DETAILED DESCRIPTION OF THE PREFERRED EMBODIMENT

The present invention will be described in detail with reference to the accompanying drawing in which like reference numerals designate similar or corresponding elements, regions, and portions. The present invention provides a method for electronic registration of assets in a registration database, using an electronic data file, called an E-registrar. It should be noted that the present invention can be applied both to online purchases (i.e., e-commerce) and to conventional purchases (i.e., at a brick-and-mortar store). It should be further noted that the electronic registration database can be provided by the manufacturer, by a re-seller, or by a third party.

The present invention provides a method for registering assets comprising the steps of providing an electronic data file with data specific to an individual or organization that purchases or owns assets, providing a registration database in which assets are registered (E-registrar does not require a particular registration database per se; while such a database will ultimately be used somewhere, the e-registrar provider could be an intermediate third party that does not maintain the database) and extracting the purchaser-specific data from the data file and sending that data and separately input asset-specific data to the registration database (or agent managing the db). The application or applications that extract purchaser-specific data, input asset-specific data, and send all of the data to the registration database can be run on one or more of a variety of computers. As will be apparent to one of ordinary skill in the art, a common protocol must be established for extracting and sending data. The purchaser-specific data file, called an E-registrar, can be an electronic file on a storage media that is accessible to a purchaser's computer (e.g., integrated into the OS or web browser, smart card reader), or could be maintained by a third party (e.g., credit card company website where purchaser creates and updates his E-registrar file via the Internet). The data on this electronic file can be extracted during the purchasing transaction (e.g., point-of-sale (POS), online) or can be extracted in a separate transaction initiated by the purchaser after the purchasing transaction.

Alternatively, the E-registrar can be an electronic file stored on a smart credit card. The data in this file could be extracted at the POS. Another alternative would be to have a third party, such as a credit card company, maintain the E-registrar on a storage media accessible to its computer. In the credit card company example, the purchaser-specific data could be extracted during the approval cycle for the purchasing transaction. The asset-specific data could be input in a variety of ways including bar scanning or manually entering asset identification, such as serial number, at the POS or directly from the manufacturer in a separate transaction. The purchaser has control over their data, and the e-registrar function allows for updates and changes to the individual's e-registrar. This would allow for the changes both to the data file as well as the registration database (e.g. universal change of address notification).

Following are examples of specific implementations of the present invention. These examples show that various configurations of purchasing transactions can be accommodated. Also, various assignments of the responsibilities within the registration system, such maintenance of a registration database, are possible. These examples are of illustrative and not limiting of the invention. As will be apparent to one of ordinary skill in the art, other implementations of the present invention are possible and are well within the scope of this invention.

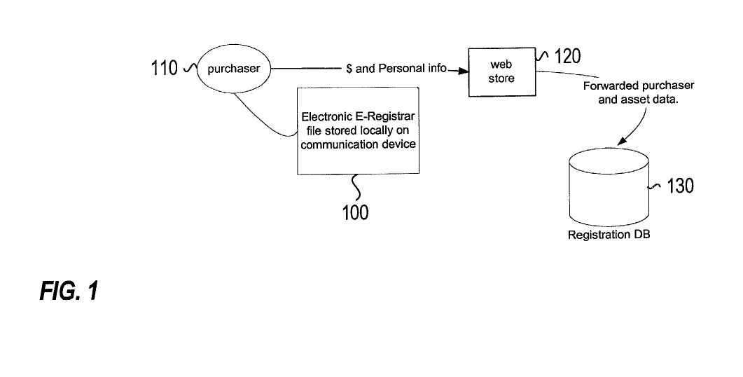

FIG. 1 illustrates an example of the present invention in which a purchaser (110) buys an asset on-line from a seller (120) which in this embodiment, is an asset manufacturer website, and a registration database (130) is provided and maintained by the asset manufacturer (120). The purchaser's E-registrar (100) is in the form of an electronic file on a storage media (e.g., hard drive) accessible to the purchaser's communication device, which may be a computer, cell phone, personal digital assistant (PDA) or other devices that well known or later developed that provide a communications link between the purchaser (110) and the seller (120). The electronic data file comprises data specific to the purchaser (110). In this example, the purchaser (110) has established a communication link with the seller (120), typically through the Internet. During or at the conclusion of a transaction to purchase an asset, the seller (120) prompts the purchaser (110) to register the asset being purchased. The purchaser (110) then registers the asset by activating the E-registrar (100). This allows the seller (120) to extract the data specific to the purchaser (110) and send it to the registration database (130). The seller (110) also provides data specific to the asset to the registration database (130). The data sent form the purchaser (110) to the seller (120) could further comprise payment information such as a credit card number. This information can be part of the E-registrar (100) or can be transmitted separately. It should be understood that, in this example, the seller (120) could be a re-seller, and the re-seller could forward the information to the manufacturer who would maintain the registration database or the re-seller could maintain the registration database for the manufacturer

The E-registrar can be activated in a variety of ways, as will be apparent to one having ordinary skill in the art. For example, the E-registrar could be loaded into a communication device such that an E-registrar icon is present on a desktop. This would allow the E-registrar to be activated by either clicking on the icon or dragging the icon onto a registration window. In another example, the manufacturers transaction application would automatically search for the E-registrar and extract the desired information. A key advantage of the present invention is that the purchaser does not have to manually enter the data necessary for asset registration for each asset purchase. The E-registrar can significantly increase the incidence of asset registration and provide more complete information in the registration process.

The registration database (130) allows the seller (120) and other interested parties to access and analyze data about the entities that purchase and own their products. The registration database (130) can also be used to track life cycle attributes of the asset such as usage, maintenance, and customer satisfaction. The purchaser (110) can also be given access to the registration database (130), providing a record of the purchaser's assets. Potential purchasers could be given access to aggregate data concerning customer satisfaction and other attributes as a discriminator for purchasing a particular asset. An asset registration database is described in detail in Applicant's co-pending U.S. patent application Ser. No. ______ (docket T900-10), filed concurrently with this application on Dec. 18, 2000, which is incorporated herein by reference.

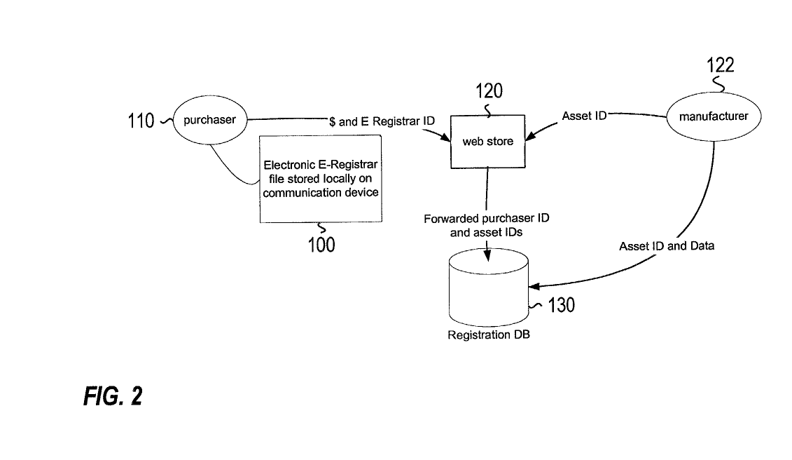

FIG. 2 illustrates an example of the present invention in which an asset is purchased on-line from the seller (120), and a third party provides the asset registration database (130). The purchaser (110), who can be any type of entity (e.g., individual, corporation, or other organization), has an E-registrar (100). For on-line purchases the E-registrar is preferably an electronic data file comprising data specific to the purchaser. In this example, the purchaser (110) establishes a communication link with the seller (120) for the purpose of completing an on-line transaction to purchase an asset, preferably through the Internet. During the on-line purchasing transaction, the seller (120) prompts the purchaser (110) to provide financial information and information specific to the purchaser (110) for use in registering the asset using an e-commerce application. The purchaser (110) can provide the registration data (and optionally, the financial data) by activating the E-registrar (100). The seller (120) can separately extract asset identification data from the manufacturer (122). The seller (120) then associates the data specific to the purchaser (110) (e.g., identification) with data specific to the asset (e.g., identification) and sends the combined data to the registration database (130). As shown in FIG. 2, the manufacturer (122) can send general data, such as specifications, for the asset directly to the registration database (130).

The third party registration database provides several advantages. First, a purchaser (110) can access data for all of the purchasing entity's assets from a single database, providing a useful asset management tool. Also, interested parties, such as marketers, can access aggregate data and consumer profiles from a single source. Another advantage is that a third party, such as a credit card company, can use the asset registration database (130) as an incentive to encourage individuals or organizations to do business with them.

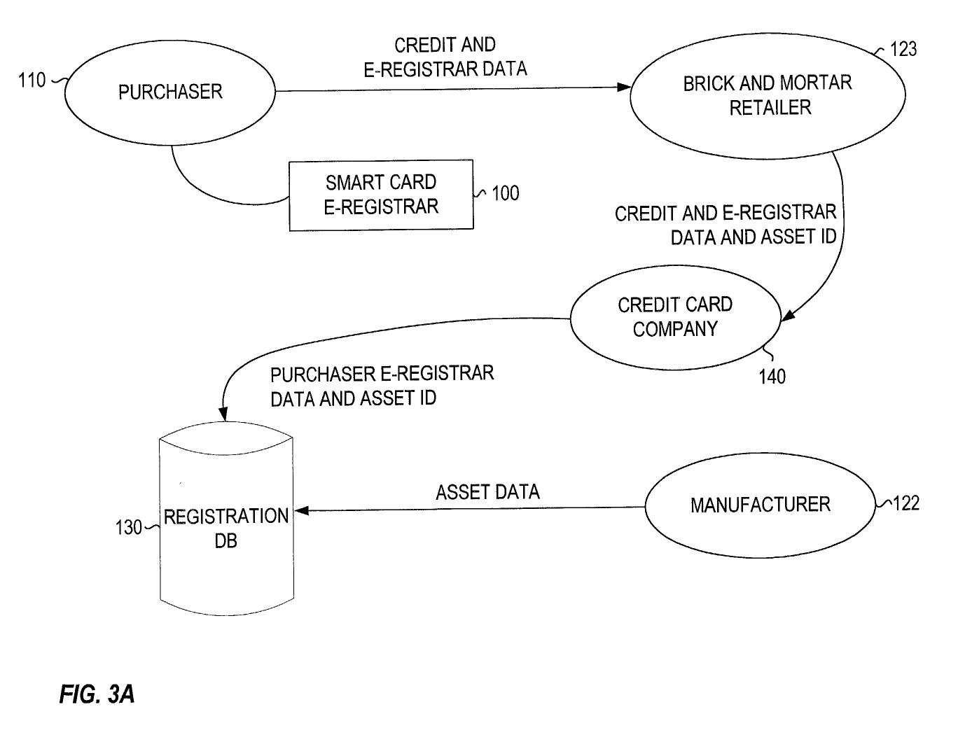

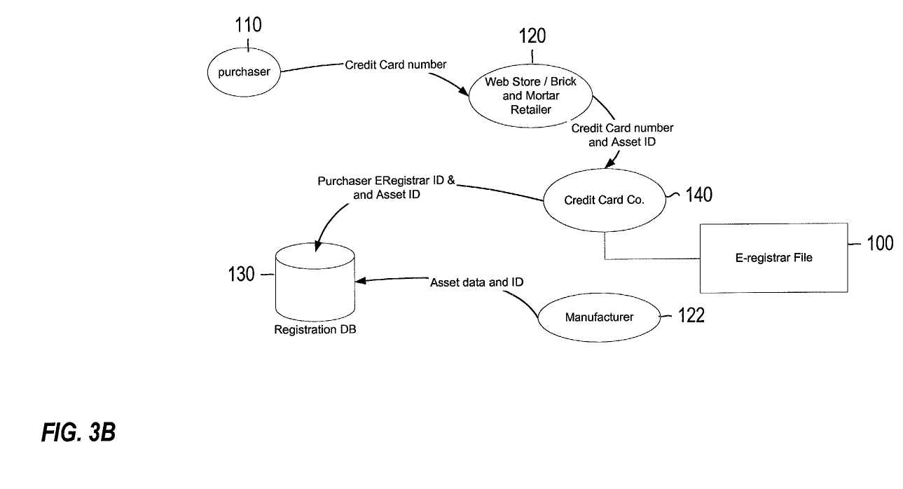

FIG. 3A illustrates an example of the present invention in which an asset created by a manufacturer (122) is purchased from the seller (120) using a credit card and the third party credit card company (140) provides the asset registration database (130). In this example, the E-registrar (100) would be in the form of a data file on a smart credit card for transactions at brick and mortar retailers. A smart credit card is a credit card with electronic files stored thereon, such as in a microchip on the card. When the retailer (120) establishes a communication link with the credit card company (i.e., swipes the card over a magnetic reader or enters the credit card number), the credit card identification and the E-registrar data are both sent to the credit card company (140). The retailer (120) also provides asset classification and identification to the credit card company (140) over the communication link. The credit card company (140) then follows its typical analysis and approval process with the credit information. However, the asset identification and purchaser E-registrar data are sent to a registration database (130). Asset information, such as specifications and warranty are sent to the registration database (130) directly from the manufacturer (122).

Alternatively, the credit card company (140) can maintain the E-registrar (100) as shown in FIG. 3B. In this embodiment, the E-registrar (100) would be in the form of an electronic file located on a storage media accessible to the credit card company's computer. The E-registrar (100) would be activated when the credit card company (140) received a communication comprising the particular purchaser's credit card number. One advantage to this alternative is that data specific to the purchaser (110) would not be available to every seller (120) the purchaser (110) engages in purchasing transactions with. This includes any on-line sellers and brick and mortar retailers, whether they are manufacturers, re-sellers, wholesalers, retailers or any other sales organization. It should be noted that an E-registrar (100) maintained by a credit card company (140) could also be used for on-line purchases. Similar to the conventional retailer scenario, an E-registrar located on the credit card company's computer would protect sensitive purchaser-specific data from on-line re-sellers.

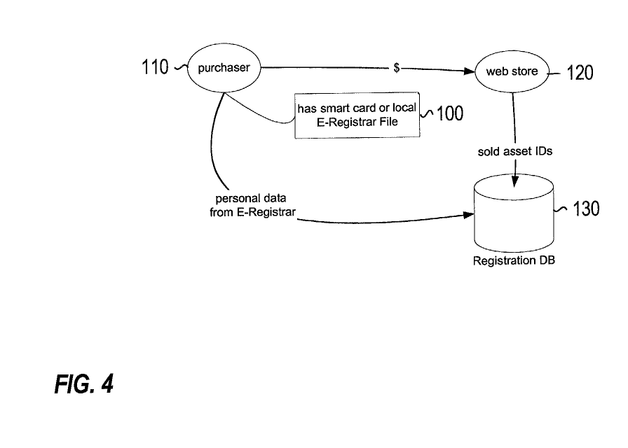

FIG. 4 illustrates an example of the present invention in which an asset is purchased from an on-line seller (120), the manufacturer (122) provides the asset registration database (130), and the purchaser (110) communicates the E-registrar data directly to the manufacturer. In this example, the E-Registrar (100) would preferably be in the form of a data file on or accessible to the purchaser's communication device. The purchaser (110) sends financial information to the on-line seller (120). The purchaser (110) then sends the E-registrar data directly to the manufacturer's registration database (130). This can be accomplished by an application run on the purchaser's communication device that establishes a communications link with the registration database (130), such as through the Internet. The identification of the asset can be sent to the registration database (130) by the on-line seller (120) as shown in FIG. 4. Alternatively, for an on-line seller (120) who does not participate in the E-registrar system, the asset identification can be sent to the registration database (130) by the purchaser (110) after receiving the asset.

In one embodiment of the invention, the purchaser-specific data can include insurance information, such as insurer and account number. This insurance information can be extracted and sent to the insurer, or the information can be sent to the registration database and the insurer can be given access to the registration database. The insurer can then provide automatic insurance coverage for an asset from the POS. This embodiment would be easy to implement in a system in which a credit card company maintains the registration database and the insurer and the credit card company are commonly owned.

Alternatively, the insurance information could be a standalone file called E-insure providing insurance coverage with less manual data entry than traditional insurance application processes.

When an individual, group, or business purchases or leases any product or service, the registration of that product or service is performed automatically. This automatic registration would preferably be carried out over a network (e.g. Internet) at the time of purchase, but could also be done at any time both prior to and subsequent to the purchase or lease. There are a multitude of scenarios and applications to which this concept of automatic registration can be applied. The following described applications are examples that illustrate concepts, methods, and utilities associated with automatic registration of assets, but are by no means inclusive of all possible applications and implementations. When used herein the term purchase is meant to include any and all forms of acquiring any form of ownership or use privileges regarding an asset, including for example, leasing. Also, the term product is meant to encompass all things of value which are exchanged for fees or other consideration including services. It is also to be understood that the concepts, inventions, and business methods described herein are applicable to all interested parties including but not limited to, business-to-business, business-to-individual, individual-to-individual transactions (including after-market reselling) and the like.

One example of automatic registration of an asset is that of simply registering the item with and according to the manufacture, re-seller or other parties involved in some way with the production, sale, warranties, service, or other responsibility regarding the asset. Examples of such parties which request or require their customers to register products are software vendors such as Microsoft, electronic manufacturers such as Sony, durable goods producers such as Sears, automobile manufacturers, etc. The E-registrar provides the purchaser a simple and straightforward way to provide, in an electronic format, all of the purchaser's registration information, such that each time a purchase is made and registration is needed, the purchaser simply uses his own electronic E-registrar to automatically and seamlessly register the purchased asset with minimal effort. The implementation of the E-registrar can be done in a variety of ways to suit particular applications. The E-registrar would preferably be an electronic file or other electronic (digital or analog) unit of information that is stored on a communications device or a smart/credit card.

Each prospective purchaser would have his or her own E-Registrar that would contain any and all pertinent information deemed appropriate or necessary by the purchaser or other interested parties. Which specific information needed could be recommended by manufacturers and vendors or financiers (e.g. credit card companies). The implementation of the E-Registrar could be performed by any interested party, such as a credit card company on behalf of the card user or the purchaser himself. In the case of the purchaser maintaining his own E-Registrar, the purchaser would input all the personal and other data desired and/or required for registration. The automatic registration would ideally be a “one-click” registration offered as service by the manufacturer, vendor, or other interested party. Subsequent to the purchase (and perhaps registration), one-click updating of registrations would also be a possible embodiment (e.g. when an owner changes residence and wishes to notify the registrar).

In the cases of online purchases, the purchaser would have an E-registrar “file” on his communication device, preferably on the desktop. In the case that the purchase is made directly from the manufacturer or other party that offers online registration, the E-registrar would be provided by the purchaser along with other purchasing information. An example of how the E-registrar is provided to the vendor manufacturer is by a ‘drag and drop’ E-registrar icon, or alternatively as a file or other unit which can be sent across the network to the manufacturer. The purchaser would send his personal E-registrar via his web browser or email, which would contain standard information needed for registering the asset, to the manufacturer. The manufacturer would extract the pertinent information from the E-Registrar and register the product, and the registration process would be accomplished. The manufacture would provide verification of registration and other information (e.g. warranties) either on the spot through the browser or email, or subsequently through other means, such as mail or facsimile. One embodiment would be tantamount to a “one-click register” similar to the one-click-purchase via Ewallet™. The E-registrar on the desktop would be supplied by a third party (software producer, web portal, shopping site, etc.) and/or could be integrated into an operating system (e.g., Microsoft would add the feature to its Windows™ operating system). Alternatively or additionally, an application would be developed (e.g. to reside on the desktop) that would provide for the automated (i.e. “one-click”) addition of user or other information to a form (online or otherwise) which would ultimately be sent/retrieved over the network to the appropriate interested party(s). Such forms could include warranties, guarantees, and insurance (e.g. E-warranty, E-Guarantee, E-Insure analogous to E-Registrar).

In another embodiment, individual vendors (e.g. website.com), could offer this service to prospective purchasers, either on an individual vendor basis or through a 3rd party. In either case, the vendor could become a “certified E-registrant site” by virtue of its offering and compliance with governing E-registrar protocols.

The more general case however, of purchasing online from 3rd party re-sellers who do not typically offer the service of registering the product with the manufacture, a new service and business method may be implemented via the E-Registrar. The prospective purchaser would have created/customized his E-Registrar (e.g. on his desktop) as described above, and the purchaser would provide (e.g. drag and drop and icon) to the vendor or re-seller when making the purchase. The re-seller would provide the service of registering the purchased item with the manufacturer for and on behalf of the purchaser. A registration verification or certificate (electronic or otherwise) could be provided to the purchaser confirming registration, warranty and other information.

This could be accomplished in many different ways. One way would require vendors and re-sellers to have an established protocol for this automatic registration, such that at the time of purchase, the re-seller's servers communicate and exchange registration, warranty, and other information with the servers of the manufacturer (or other registration interested parties) over a network (e.g. Internet). The identity of the asset purchased would be determined and tracked from its unique information including its model and serial numbers, and SKU. The re-seller/vendor would provide this item's identifying information along with the appropriate registration information obtained from the purchaser's E-Registrar to the manufacturer. The manufacturer could then register (preferably automatically) the item/purchaser, and provide either through the vendor or directly to the purchaser, a certificate of registration, warranty information, and any other information including marketing and advertising desired by the purchaser or manufacturer. As is readily apparent, there are many applications, business and implementation models which are encompassed by the E-Registrar and automatic registration concepts.

The E-Registrar concept would be implemented in a similar manner for those purchases that are made “off-line”, for example in a department store in a mall. However in this case, the electronic E-Registrar would be stored on an “electronic card” (e-card) such as a credit, debit, or most generally, a smart card. The purchaser or user of the smartcard would create or modify his own E-Registrar on the smartcard and the purchaser's E-Registrar would be extracted at the point of sale at the time of purchase. Alternatively, the credit card company could set up the user's E-Registrar. A similar implementation as described above wherein the vendor communicates with the manufacturer over the Internet or other network, sending the item identifying information along with the purchaser registration information extracted from the purchaser's E-Registrar. In this case, the E-Registrar information would be extracted at the point of sale (POS) when the card is “swiped”, scanned, or otherwise used to effect the purchase. The manufacturer and/or vendor could provide a real-time on-the-spot certificate of registration and warranty information or alternatively would send the purchaser these information later via a variety of routes, including email, U.S. mail, etc.

The E-Registrar is also valuable for registering assets even if such registration is not automatic (i.e. the registration does not happen automatically at the time of purchase). For instance many manufacturers and vendors are offering online registration of their products. This online registration service is usually subsequent to and independent of the actual purchase transaction in which case automatic registration was not possible or implemented. This post-sale online registration requires the same tedium of filling out an online form that becomes laborious and time-consuming when the purchaser seeks to register many products from many vendors.

The personal E-Registrar solves this difficulty by allowing the purchaser to simply input his E-Registrar (e.g. electronic file) into the online registration form/process. This input could be accomplished via attaching the E-Registrar to an email message in the case of email registration, or more preferably, by simply dragging and dropping an E-Registrar icon over the registration form which then extracts the needed data from the E-Registrar. The time saved by the purchaser is evident because the user only need put his or her registration information into the E-Registrar once, and use the same E-Registrar to register all his assets via the online registration process.

The example of buying multiple software packages (i.e. from multiple producers) through one site (e.g. beyond.com) serves to illustrate one utility on the E-Registrar. In this instance the purchasers is able to register with each producer with one E-Registrar file and in a preferred embodiment, with just one-click. This feature is extendible to all such purchases that involve multi-producers or multi-vendors (e.g. Yahoo shopping).

In another example embodiment, each E-registrar would have “journal” or logging functionality such that the user would have a record of specific registrations that took or attempted to take place via the E-Registrar. This would allow for one application to serve multiple users (similar to the way an email client application allows for multiple identities and corresponding information).

The information a prospective purchaser or other party decides to include in the E-Registrar is up to the interested parties, but it is envisioned that the E-Registrar would contain the minimal information needed by the registering organization including name and address (including email) of purchaser, but also additional information of interest to the interested parties, such as income, interests, age, marital status, and all types of marketing “survey” type information, such as hobbies intended use of product, etc.

Creating an E-registrar on computer or smart/credit card, either an editable or non-editable repository of information would be well within skill of anyone skilled in the art. An example of a drag and drop or “e-mailable” “file” for e-commerce applications is the well known Ewallet™ which is similarly used for one click shopping and which allows the purchaser to only have to enter his purchasing information once. Similarly, for off-line purchase with an “electronic card” such as credit/debit/smart card, it is well within the ability of someone skilled in the art to create such an E-registrar on such a card.

An asset registry would be one or more databases linked via a network in which the assets of individuals, businesses, and other asset interested parties would have access to asset records. Although the databases and other infrastructure may be distributed, the Asset Information Registry (AIR) would preferably be centrally accessible, for instance with a web (HTML) browser and over the Internet. In one embodiment, all assets owned by individuals and business would have records associated with each of the assets, these records being stored in the AIR. The scope and content of these individual asset records could be as narrow or as wide as desired. This asset registry could be manufacturer specific (e.g. Sears), it could be item class specific (e.g. electronics), or it could be generic including all types of assets, just to name a few possibilities. In the case of manufacture or vendor specific, a company such as Sears would provide as a service to its customers, the automatic registration and maintenance of all items purchased at Sears.

For the item class AIR, manufacturers and/or distributors would maintain the registry of a class of assets. In the most general case, of registering all assets, a third party or parties (e.g. insurance organization such as Travelers, a finance organization such as Citibank, an independent.com) working alone or together would provide such a service to businesses and consumers. An individual purchaser or individual business would have all assets purchased via a credit card or other non-cash way automatically registered in an asset registry. This registration could be performed by any interested party but in this example is done by the credit card company, bank or other party which is directly involved in the transaction. Alternatively, an asset could always be registered by the owner (or other) subsequent to the purchase via an Internet interface. Each separate purchasing party would have its own registry consisting of records of all assets purchased, owned, or otherwise related to the party. These asset records could be created at any time but in the preferred embodiment they are created at or soon after the time of purchase. It is envisioned that multiple forms of ownership may also be provided for by an E-registrar (e.g. joint, time limited ownership, transfer of ownership rights, etc.).

One potential business scenario is now described although it is to be understood that this is but one example and many more potential applications exist. In this example, a financing/credit-issuing organization, such as Citibank, would provide this generic asset registration service. This service would be integrated and dependent on the purchaser using the credit card company's card to purchase the asset. The credit card company would automatically register the asset for the purchaser, the purchaser having access to all these registered asset (and records associated with) via a Web browser over the Internet. In the case that all pertinent information about the asset could be obtained during the purchase transaction, the initial asset record would be substantially complete. In another case where some detailed information about the asset is not obtainable during the purchase, an initial record would still be created with the expectation that additional information would later be added by an interested party. Such parties include the purchaser, vendor, and manufacturer.

For example, the automatic manufacturer registration as described above could be utilized and integrated into the generic asset registry such that the purchaser or the vendor, or preferably, the credit card company (e.g. bank) would register the asset with the manufacturer and this registration, warranty, and other information would be put into the asset record with the registry. The E-Registrar concept as described above would be applicable to these scenarios. Preferably, the credit issuing organization would have an established relationship with manufacturer and vendors such that this automatic manufacturer's registration could take place (e.g. via the Internet) and this registration information would become part of the asset record in the AIR. In the case of online purchases, Internet credit cards (e.g. NextCard) would be an ideal way to implement the above. Indeed, any sub-component of the concept of a “one-click” automatic registration of asset whether it be the traditional manufacturer registration or whether it be the registration of an asset as a record in a global asset registry, among other variations, would be easily implemented via Internet credit cards or other online financing, insuring, purchasing organizations.

The automatic registration of assets including manufacturer's registration as well as the generic registration of all assets purchased and owned by an individual party may be accomplished by a single organization, or alternatively through a collaboration of organizations with the interest in the asset and/or purchaser. Such parties include, purchaser, manufacturer, vendor, financing and insuring organization, taxing and regulating organizations, service and repair organizations, etc.

One example of such a collaboration would be that of the asset owner, the financing organization, and the insuring organization, in the case of insured assets. For example, a purchaser may want a particular asset which he has purchased to be insured, or he may want all the assets which he owns and subsequently purchased to be insured. Both cases necessitate a collaboration with an insuring organization at some point during asset registration, either simultaneous with or subsequent to such registration. In the first case, where a particular asset is purchased and the purchaser would like the asset insured from the time of purchase, the insurance information would be a part of the purchaser's E-Registrar, and the asset information would either be automatically sent to the insurance company (e.g. via E-Insure functionality), or in the preferred embodiment, a collaboration would exist between the credit and insurance company such that everything purchased with a particular credit card would be automatically insured. This insurance information would become a part of the asset record as well.

In another embodiment, where a purchaser wants all the assets purchased to covered, not necessarily individually, but as part of a policy offering broader coverage such as homeowner's or renter's insurance. Such insurance typically covers personal assets within a person's residence. Traditionally, for valuable items in particular, the owner would have to notify his insurance organization that he had obtained an item and provide some way of establishing and substantiating the items value. But in the case of this embodiment of the automatic registration and insuring of an asset, the relevant asset information would be automatically sent to (or extracted by) the insurance company via the automatic registration process and the asset would then be automatically insured, the purchaser having to do little or nothing regarding notifying the insurance company, the asset being automatically registered, in one case as personal property owned or maintained within a residence in which cases the asset would be insured under an ‘umbrella’ policy.

In one preferred embodiment, when a purchase is made via electronic means (e.g. Citibank credit card; on/off line) the asset will automatically be insured by either the purchaser's preferred insurance company or by another insurer with an overlapping interest in the financial transaction (e.g. Travelers Insurance). Citicorp would offer this service, along with Travelers for instance, of automatically registering and insuring of the purchased asset. The insurance could be semi-permanent and renewable, or it could be in the form of transition insurance until the purchaser insures the asset with another organization. Citicorp/Travelers could even facilitate such as transfer of insurance.

In many instances finance companies have a vested interest in the insuring of asset which they financed. This is usually the case with big-ticket items (e.g. automobiles) where the purchaser must finance the asset over an extended period of time. Regardless of the time period however, the finance company may view the purchased asset to some extent as “collateral” for the extended credit. In these cases, the owner is usually required or encouraged to obtain insurance on the asset. The automatic asset registration provides an ideal and seamless way for an asset to be both financed and insured simultaneously, perhaps by the same company. Regardless of which companies are involved however, this ability to relatively seamlessly finance and insure and asset, through the concept of e-registration (automatic and otherwise), provides a very powerful and convenient method for purchasers, insurers and financiers, to solve difficulties regarding registering, financing, and insuring assets. In addition to the integrating the insurance side of an asset with the finance side, “one-click insurance” could be offered by an independent insurer as an additional or alternate service (see discussion above regarding one-click-registration for details on implementation). This could be implemented as an “E-Insurer” icon or other data unit similar to that as described for the E-Registrar.

All pertinent records regarding asset, including financing and insurance information, would preferably become part of the generic asset record.

The web portal Yahoo™, provides a multitude of services including advertising and providing an online shopping “mall” representing many manufacturers and retailers. Manufacturers and retailers advertise their products on the web portal, and the portal also provides links to the vendors' web sites and catalogs. Visitors to the portal can thus find many items of interest to purchase in a centralized place, the web portal. When a purchase is requested or made, Yahoo™ handles the financial transactions and acts as a “broker” between the buyer and vendor. This is convenient to consumers who can shop at many different stores, but yet only need deal with one party (Yahoo) when it comes time to “check-out”. A purchaser may wish to purchase dozens of items from dozens of stores, but she only need provide her billing information once, to Yahoo, in the form of a Yahoo Wallet™. However, registration of manufacturers product's still proceeds the conventional way.

In the present embodiment of automated registration, a web portal or other “shopping mall broker” as described above would not only provide an Ewallet such that all purchases can be handled with only one “wallet” or one exchange of financial information, but would also provide an E-Registrar, which would allow a purchaser to provide, only once and in one format, the information necessary to register the product with the manufacturer or other party. While the Ewallet stores billing and shipping info, the E-registrar would store in addition to shipping and billing data, information required or requested for registration, such as age, income, interests, and any other non-item specific information desired by the registering organization.

The shopping broker (e.g. Yahoo) service would provide this E-registrar to the manufacturer/vendor who would register the product in the name of the purchaser either automatically and on the spot, or subsequent to the purchase and either prior to or subsequent to shipping. This would alleviate the need for the purchaser to register the product after receiving it, as it currently done. Yahoo would have established the registration protocol with the manufactures/vendors, and/or act as broker with purchaser by providing the purchaser with the appropriate item and manufacturer information such that that individual could directly (e.g. automatically) register the product, via the manufacturers website for instance. Alternatively, the vendor could provide a “file” to the purchaser (e.g. the purchaser's computer) which could then be used to register the asset (e.g. by automatically sending the “file info” to a registration service provider.

Although the above example is directed to manufacturer registration and the like, the same methodology could be utilized for the generic registration of asset (i.e. owner asset registration) and creation of asset records in a centralized asset registry as described above. Such technology and methods could also be used for automated or one-click: insurance (E-insure), escrow (E-escrow), warranty (E-warranty), guarantees (E-guarantee), service (E-service), etc.

One example of online and off-line purchases is a credit card company (e.g. Citicorp) provides automated registration of assets. Credit cards, debit and check cards, and smart cards are widely used to make both online and off-line purchases. Automatic manufacture registration would be a service offered by Citibank, for example, to customers who use the Citibank Visa.

The registration information (i.e. the E-Registrar), including shipping, billing, and other non-item specific information which may be solicited for registration purposes would be obtained from the consumer from Citibank and stored in one or more accessible locations to be used when purchasing an item. When a purchase is made by a customer the E-registrar data is sent to the manufacturer automatically (e.g. across a network) such that the manufacture can register the item in according to the information contained within the E-registrar. In one embodiment, the registration information (i.e. the E-registrar) would be stored on the smart/credit card, and could be extracted at the point of sale. This would be particularly applicable to online credit cards such as NextCard™ used for online purchases. In a preferred embodiment, Citibank would maintain the registration information for each customer on his or her computer servers which would be linked to a network (e.g. Internet or corporate intranet). This information could be solicited from the consumer in many ways including over the Internet via a web browser. A customer could log onto to Citibank's computers and update her personal information including her E-Registrar information. When an item was purchased with the credit/smart card, Citibank would receive notice of the transaction (at POS or subsequently) which would include details on the item purchased. These details would include, among other, manufacturer and item/model number. These data can be extracted by a variety of means as will be evident to those skilled in the art. Citibank, having these details, would send to the appropriate manufacturer (or other interested party) the details of the purchase/transactions including the customer's E-Registrar information and item purchased information. The manufacturer would then register the asset in the customer's name, and send confirmation and other desired information to the customer or to Citibank which would maintain and/or forward the information to the customer.

In either case, protocols and procedures would have been established between vendors, Citibank, and manufacturers, (and other interested parties) such that the registration information per consumer per purchase would be transmitted across the network, either from the point of sale (POS) or from Citibank's computers.

Although the above example is directed to manufacturer registration and the like, the same methodology could be utilized for the generic registration of asset (i.e. owner asset registration) and creation of asset records in a centralized asset registry as described above. That is Citibank could provide the same registration service for its customers, but not simply the manufacturer's registration, but the registration of all assets purchased (with Citibank's card) in a central repository as described above. This could be a 3rd party repository, or preferably Citibank itself would maintain the repository as a service to its customers. Such technology and methods could also be used for other types of automated or one-click services as mentioned above.

In a preferred embodiment Credit Card Company (e.g. Citicorp) provides automated registration of assets and in collaboration with an insurance group (e.g. Travelers) insures the item purchased as well. This would require established protocols between Citibank and Travelers. However because the finance and insurance organizations are becoming increasingly interdependent and intertwined, the implementation of such a plan would be almost seamless, especially in the case where both the finance and insurance organizations are commonly owned as in this example.

In another embodiment, a Citibank customer provides Citibank, along with her registration information, her insurance information as well, such as the name of the insurance company, the policy number, etc., which would be maintained and stored on the credit card and/or Citibank's computers. This could include all types of insurance including automobile and in this example, personal property insurance, including home-owners and renters insurance. This would require an established protocol between Citibank and the insuring organization, and the communication would occur, preferably over the network, but could also be done by other conventional means (e.g. mail and fax).

When an item was purchased by a customer with the Citibank card, Citibank would obtain the details of the item/asset, either from point of sale data or from other sources such as the manufacturer. Using the insurance information supplied by the customer, Citibank would send to the insuring agency, on behalf of the customer, details on the purchased item. The insuring agency would then have an asset record, and could immediately insure the asset, adjust premiums, etc. Other variations of this automated insuring of assets with different interest parties assuming different and various responsibilities will be evident to those skilled in the art. The automated or one-click insurance could also be implemented as a stand-alone service (E-insurer).

It is clearly evident that the above described business model of automatically insuring assets (or of automatically notifying customer's preferred insurance provider) at the time of purchase could also be implemented by a web portal such as Yahoo™ as described above in that example, by providing Yahoo™ with the insurance information as part of the user's E-Registrar, as well as in other embodiments independent of the E-registrar (e.g. E-insurer).

According to another embodiment, the current invention provides automatic search of the registry and other sources to identify other similar items of less cost or other desired traits, or the same item of less cost from a different vendor. The registry can be implemented in a variety of ways and by one or more different interest parties. In any case, because the item purchased, or to be purchased, is registered in the central registry (including item-specific, vendor and financial information) a service would be offered, by for example, Citibank Visa, a web portal hosting online shopping, an independent.com, etc., which would, take the item and financial information, and attempt to locate the same or similar item for sale at another location, the purchase of which would be more advantageous to the consumer.

The search could proceed according to a number of parameters, set by the consumer or service provider. These parameters would include any attributes of interest to the consumer, including price, tax, shipping, warranty, where when, and how manufactured, etc. There would be a default parameter, such as lowest price, and the consumer could modify the default criteria if desired. If the results of the search for comparable or “better” items/prices were found, then the consumer would be automatically notified, by email or epager for instance. Purchaser can then return the previously purchased item or cancel the order, and get the lower cost or “better” item instead. Alternatively, the service provider would perform the return/cancel action on behalf of the consumer such that the process is relatively seamless to the purchaser.

This type of service would be straightforward to implement as will be evident to those skilled in the art. The purchasing, registration, and alternate product search would be done via the Internet and web browsers, using known or developed, free or proprietary search engines or other algorithms. Instead of “naming your own price” or reverse auctioning as it is known, the present service, would record the purchase details, including the item identifier and specification and financial details, and import this information into registry. A search of its own and other databases for all places that sell item and compares specifications and price. If an item which matches the user criteria/filter (e.g. only notify me if a and b and . . . ), then it will notify the user by email or epager.

Alternatively, if this service is run by a credit card company, such as VISA or Citibank, notification of user would be unnecessary as VISA, because they are financing transaction, can cancel one order and generate the other after having found the better deal (i.e. having found a better match based on purchaser's default or input criteria). This is another example of a service which would be provided by, for example, a credit card company. Citibank, for example would offer the service to its customers as an incentive to use Citibank's card. Citibank may guarantee that it will find the lowest price or other desired attribute, for instance.

An alternate embodiment of the above described method and service of finding a “better deal or item” after purchase is that of finding the “better deal or item” prior to the actual purchase. For example, a purchaser may be shopping online at the Yahoo web portal or other online site when she finds an item she likes or is interested in potentially purchasing. She could mark the item as a “tentative purchase,” which would then alert the “find a better deal or item” service provider or algorithm of the impending purchase, the service would then search the Internet (and other sources) for comparable or related items depending on the default or purchaser's criteria. This type of service could be implemented by for instance, Yahoo, or a 3rd party.com offering such a service. Default user parameters could be stored with the provider and/or on the user's desktop, to be provided and/or accessed automatically, and such that the user need only set the default parameters once, if desired.

In another example, an E-Broker would provide a service (to purchaser or vendors, or marketers), such that a prospective purchaser would “flag” a particular item or describe a general type of item, and specify desired purchase parameters, and that a purchase was impending (e.g. w/I 24 hours, for x$, with a particular warranty or service contract, etc.) A service would then attempt to match the purchaser's requirements, and/or “beat” the purchaser's described impending purchase, based on supplied parameters, (e.g., by searching websites; allowing vendors to bid on making the sale, etc.), in which case the “better deal” purchase is effected. The commitment to purchase may be tentative, but in the preferred embodiment, the purchase by the consumer is guaranteed (e.g. credit card charges and authorizations may be obtained) such that those “bidding for sale” would be guaranteed to consummate the sale in the event their bid was the best.

An auction house which provides 2nd hand buying, selling, and comparing marketplace and which provides an automatic market value appraisal of asset based on purchases of others (new and used), and assistance to potential buyers to find the same product and/or the same lowest price. One advantage over eBay is that assets were automatically registered when bought (or subsequently), and thus owner need not re-register with auction house. Owner need only flag item as “on sale”. This would also provide opportunities for advertisers (e.g. banner ads).

In one embodiment, interested parties (e.g. buyers) would be able to view the assets in the registry, and be able to submit blind offers (i.e. they may not know the owner's name), in which case the owner could ignore, accept, or respond accordingly (e.g. negotiate, even anonymously).

In another embodiment, the present invention may allow owners to evaluate and rate assets. An owner could input satisfaction/dissatisfaction (e.g. standardized review form). Potential buyers would search website for class of assets or particular asset for price and review information (banner ad opportunity). The improvement over conventional asset review/rating (e.g. CNET.com) sites is that only authentic owners would be able to provide review information because the registry would provide the means of substantiating or authenticating the reviewer's claim of knowledge (via ownership) of the asset in question. This would prevent other's from artificially “hyping” a product, and help to insure a “one owner, one vote/review” rule.

The descriptions and example embodiments of asset registration, as discussed above, are not meant to restrict the broad scope of asset registration, their implementations or applications. As will be evident to those skilled in the art, many variations and extensions, implementations, and applications are realizable based upon the descriptions herein. Furthermore, the E-registrar (e.g. automated and/or “one-click”) concept is easily extendible to other services including (among others): E-Insurer, E-Warranty, E-ServiceContract, etc., as will be evident to those skilled in the art.

Although this invention has been illustrated by reference to specific embodiments, it will be apparent to those of ordinary skill in the art that various changes and modifications may be made which clearly fall within the scope of the invention. The invention is intended to be protected broadly within the spirit and scope of the appended claims.

What is claimed is:

1. A method for electronically registering assets, the method comprising:
providing an electronic registration database;
providing an electronic data file comprising data specific to an entity that purchases or owns assets;
extracting the data specific to an entity from the electronic data file and entering it into the registration database;
entering data specific to an asset into the registration database; and
associating the data specific to the entity and the data specific to the asset, thereby registering the asset for the entity.

2. The method of claim 1, wherein registration is performed during the purchase of the asset.

3. The method of claim 1, wherein the electric file is provided on a media that is loaded onto a purchasing entity's or owner entity's computer.

4. The method of claim 3, wherein the data specific to an entity is extracted by an application on a second computer through a computer network, such as the Internet.

5. The method of claim 1, wherein the electronic file is installed on a media accessible to a third party's computer.

6. The method of claim 5, wherein the third party is a credit card company.

7. The method of claim 1, wherein the data file is an electronic file installed on a smart credit card.

8. The method of claim 1, wherein the data file includes data for insuring an asset.

9. The method of claim 8, wherein an insurer has access to the electronic registration database and automatically insures an asset when it is registered.

10. The method of claim 1, wherein the registration database provides a composite record of assets registered by specific entities and allows for the reporting and manipulation of the same.

11. The method of claim 10, wherein the entities maintain control over personal, and or entity registration data.

12. A machine-readable media having thereon a data file comprising data specific to an entity that owns or purchases assets; whereby data is extracted from the data file for use in automatic registration of assets.

13. The invention of claim 12, wherein the machine-readable media is loaded onto an asset purchasing or owner entity's computer.

14. The invention of claim 12, wherein the machine-readable media is loaded onto a third party's computer.

15. The invention of claim 14, wherein the third party is a credit card company.

16. The invention of claim 12, wherein the machine-readable media is a smart credit card.

17. The invention of claim 12, wherein the machine readable media has thereon a data file that further comprises insurance data specific to the entity that purchases or owns assets for the purpose of automatically insuring assets when they are registered.

18. A machine-readable media having thereon a data file comprising data specific to an entity that owns or purchases assets; whereby data is extracted from the data file for use in automatically insuring assets.
